(19) United States
(12) Patent Application Publication
(10) Pub. No.: US 2026/0288069 A1
(43) Pub. Date: Sep. 24, 2026

(54) TIMEPIECE MECHANISM COMPRISING A JUMPING DISC

(71) Applicant: MANUFACTURE D’HORLOGERIE AUDEMARS PIGUET SA, Le Brassus (CH)

(72) Inventors: Sébastien LOPEZ, Chaux Neuve (FR); Marc LEMONNIER, Les Rousses (FR)

(21) Appl. No.: 19/490,872

(22) PCT Filed: Jun. 4, 2024
(86) PCT No.: PCT/EP2024/065255

§ 371 Date: Dec. 5, 2025

(30) Foreign Application Priority Data
Jun. 8, 2023 (EP) 23178191.5

(51) Int. Cl. G04B 19/253

(52) U.S. Cl. CPC G04B 19/25373

(57) ABSTRACT

A timepiece mechanism includes a jumping disc, a driving device for driving the jumping disc including a rotary drive member arranged to be, with the jumping disc, stationary during a rest phase, and, during a jump phase, to drive the jumping disc by one step in a jumping manner in the direction of rotation, and a locking device for locking the jumping disc arranged to allow the rotation of the jumping disc in the direction of rotation during the jumping phase and to prevent a rotation of the jumping disc at least in the direction of rotation during the rest phase. The locking device includes a locking lever mounted between the jumping disc and the drive member and including a head, the locking lever being configured to move between a high locking position, and a low release position in which the head is engaged in a notch.

### TECHNICAL FIELD

The present invention relates to a timepiece mechanism comprising a jumping disc arranged to be able to jump by one step in a direction of rotation, a driving device for driving the jumping disc comprising a rotary drive member arranged to be, with the jumping disc, stationary during a rest phase, and, during a jump phase, to drive the jumping disc by one step in a jumping manner in said direction of rotation, and a locking device for locking the jumping disc arranged to allow the rotation of the jumping disc in said direction of rotation during the jump phase and to prevent a rotation of the jumping disc at least in said direction of rotation during the rest phase.

The present invention also relates to a timepiece comprising such a timepiece mechanism.

### PRIOR ART

Such a mechanism is described, for example, in the patent application CH 717 262. This mechanism is more specifically dedicated to a date disc coupled to a drive device comprising a control element mounted in a movable way between a rest position not coupled with the date disc and an increment position coupled with the date disc. The control element is mounted on a pivoting frame so as to be able to tilt between its two positions. The mechanism comprises a locking device, making it possible to prevent any accidental incrementation such as during an impact. The locking device comprises a pin mounted on the pivoting frame and arranged to engage between two edge teeth provided on the outer circumference of the date disc when the pivoting frame is in the rest position. This locking device has the risk of not operating if the pivoting frame does not return to a correct rest position so that the pin will be badly positioned. Furthermore, since the locking device is only active when the pivoting frame is in the rest position, there is a risk of a double jump if the pivoting frame does not return to its rest position in time. Moreover, this requires the design of a specific date disc comprising edge teeth on its entire outer circumference.

Another possible way of immobilising a jumping disc, which is known to the person skilled in the art, is to provide, in a conventional manner, a jumper. Such a jumper is arranged to lift against a return force exerted by a spring associated with the jumper during the jump phase so as to allow the rotation of the disc to perform its jump. In order to prevent a rotation in the direction of the jump in the event of an impact, for example, it is possible to increase the force of the spring of the jumper. However, this would have the drawback of requiring a significant force and, therefore, a large amount of energy to be consumed to lift the jumper during the jump phase.

Another known solution for locking a jumping disc during its rest phases is to use a lever instead of a conventional jumper, this lever moving between a locking position in which the jumping disc is locked and a release position in which the jumping disc is released to be able to perform its jump. The documents US 2002/080686, GB 1 035 295, FR 1 602 910 and GB 2 042 225 describe the use of such a lever. However, these three first documents all suggest associating a spring with the lever so that the latter can be held pressed against the jumping disc. As a result, the movement of the lever between its locking position and its release position requires a certain amount of energy to be able to counteract the opposing force applied by such a spring to the lever. With regard to document GB 2 042 225, it proposes a solution in which no spring is pressed against the lever. However, in this document GB 2 042 225, a drive member is provided in order to displace the jumping disc, but also a distinct additional member, consisting of a Maltese cross, with which the lever must cooperate to realise its locking and releasing functions. The drawbacks of such a mechanism comprising a drive member as well as an additional member are that it has a complex construction and that it is quite bulky.

The present invention aims to remedy these drawbacks at least partially by proposing a timepiece mechanism comprising a device for locking a jumping disc, making it possible to prevent an unintentional jump under particular conditions, for example in the event of an impact of the timepiece at rest, as well as to prevent a double jump of the jumping disc during a jump phase, while minimising the energy consumption during the jump phase.

Another object of the present invention is to propose a mechanism of simple and compact construction.

### Disclosure of the Invention

To this end, the invention relates to a timepiece mechanism comprising a jumping disc arranged to be able to jump by one step in a direction of rotation, a driving device for driving the jumping disc comprising a rotary drive member arranged to be, with the jumping disc, stationary during a rest phase, and, during a jump phase, to drive the jumping disc by one step in a jumping manner in said direction of rotation, and a locking device for locking the jumping disc arranged to allow the rotation of the jumping disc in said direction of rotation during the jump phase and to prevent a rotation of the jumping disc at least in said direction of rotation during the rest phase.

According to the invention, said locking device comprises a locking lever positioned between the jumping disc and the drive member, and preferably mounted so it is free to rotate, said locking lever comprising a head and being arranged to be able to move between a high locking position in which said head is held by an outer circumferential edge of the drive member while being able to form a rotation stop in said direction of rotation for the jumping disc during the rest phase, and a low release position in which said head is engaged in a notch provided on said outer circumferential edge of the drive member so as to be disengaged from the jumping disc, said notch being arranged to be at least partially positioned facing the head of the locking lever at the start of the jump phase so that the jumping disc is free to rotate, and to no longer be facing said head of the locking lever after the jump phase, or preferably before the end of the jump phase, so that the locking lever returns to its high locking position.

Thus, the jumping disc is free to rotate in one direction during the jump phase, and is locked in rotation in the same direction at least during the rest phase, preventing any unintentional jump in said direction in the event of an impact, for example. Furthermore, in a preferred embodiment, the locking device is active before the end of the jump phase, once a jump has been performed, so that a double jump of the jumping disc is impossible. Thus, the locking device according to the invention serves as both an anti-double jump and an anti-impact device.

According to a preferred embodiment, the jumping disc is an hour disc and the drive member is driven via an hour wheel.

### BRIEF DESCRIPTION OF THE DRAWINGS

Other characteristics and advantages of the present invention will appear on reading the following detailed description of an embodiment of the invention which is provided as a non-limiting example, and with reference to the appended drawings, wherein:
FIGS. 1 to 7 show a top view of a timepiece mechanism according to the invention in different positions on a cycle between two rest phases; and
FIG. 8 is a top view of the timepiece mechanism according to the invention in the event of an impact which is likely to cause the jumping disc to rotate in one direction and in the other.

### EMBODIMENTS OF THE INVENTION

The present invention relates to a timepiece mechanism having a jumping disc and will be described below with reference to a timepiece mechanism intended to be implemented more particularly in a jumping hour mechanism. With reference to FIG. 1, this mechanism, shown in its position in the rest phase, comprises a jumping hour disc 1 shown in part in the figures and arranged to be able to jump by one step in a direction of rotation during a jump phase, namely here to jump by one hour in the clockwise direction. More specifically, the jumping disc 1 has the form of a ring, the centre of which is A, empty in its centre, defining an inner circumference 1a and on which are distributed in a regular and orderly manner the twelve digits of the hours from 1 to 12. At least as many teeth 2 as there are jumps to be made in one revolution are provided on its inner circumference 1a. As many teeth 2 as there are jumps to be made in one revolution are preferably provided, namely 12 teeth 2 here, one tooth 2 corresponding to one hour displayed on the jumping disc 1. The jumping disc 1 is mounted on a frame of the mechanism, free to rotate about centre A. It is guided in rotation for example by runners 4. Any other guiding means can be used.

A drive device 5 of the jumping disc 1, which comprises a drive pinion 6 engaged with an hour wheel 7 of the movement of the timepiece and a drive star 8 integral with said drive pinion 6, is positioned at the centre of the jumping disc 1. The drive star 8 comprises teeth 8a, here numbering four, the role of which will be described below. The hour wheel 7 makes one revolution in 12 hours, or in 24 hours according to another variant, and slowly drives the drive pinion 6 and therefore the drive star 8 so that it rotates by 45° per hour in the counterclockwise direction.

The drive device 5 also comprises a rotary drive member 10, free to rotate about centre A. The drive member 10 is mounted on the frame of the mechanism at the same level as the jumping disc 1 and concentrically with said jumping disc 1. The drive member 10 is guided in rotation, for example, by runners 12. Any other guiding means can be used.

The drive member 10 has the general form of a ring defining an inner circumferential edge 10a and an outer circumferential edge 10b.

The drive member 10 is associated with an elastic return member 11 such as a return spring, said drive member 10 being arranged to be rotated in the other direction of rotation, here the counterclockwise direction, by winding its return member 11 during a winding phase, independently of the jumping disc 1, and, during the jump phase, to rotate in the direction of rotation of the jump, here the clockwise direction, under the effect of its return member 11 and to cooperate with the jumping disc 1 to drive said jumping disc 1 by one step in a jumping manner in said direction of rotation of the jump.

To this end, a catch 14 arranged to be able to be engaged with a tooth 8a of the drive star 8 is provided on the inner circumferential edge 10a of the drive member 10 in order to drive the drive member 10 in the counterclockwise direction for the winding phase. Thus, a rotation of the drive star 8 in the other direction of rotation, here in the counterclockwise direction, drives, via a contact between a tooth 8a and the catch 14, a rotation of the drive member 10 in said counterclockwise direction, during which its elastic return member 11 is progressively wound. This phase corresponds to the winding phase.

The teeth 8a of the drive star 8 and the catch 14 are configured so that once the rotation in the counterclockwise direction, which is necessary for winding the return member 11, has been performed, the tooth 8a continues to rotate in the counterclockwise direction while no longer engaging with the catch 14. Thus, the drive member 10 is released for the jump phase and its return member 11 releases all its energy by instantly returning the drive member 10 to a rotation in the clockwise direction so that it returns to its position during the rest phase. The teeth 8a are also configured to not drive the drive member 10 during the rest phase, said drive member 10 being stationary during said rest phase. The jumping disc 1 is stationary during rest and winding phases.

For the drive, by the drive member 10, of the jumping disc 1 by one step in a jumping manner in the direction of rotation of the jump during the jump phase, the cooperation between the drive member 10 and the jumping disc 1 is preferably, but not necessarily, direct. To this end, a flexible finger 16, for example a finger mounted on a spring blade integral with the drive member 10, is provided on the outer circumferential edge 10b of the drive member 10. The flexible finger 16 is arranged to retract on contact with a tooth 2′ of the jumping disc 1 when the drive member 10 is driven in the other direction of rotation, here the counterclockwise direction, during the winding phase, and to drive, preferably by direct contact, the jumping disc 1 by one step in the direction of rotation of the jump, here the clockwise direction, by pushing said tooth 2′ of the jumping disc 1 in said direction of rotation, here the clockwise direction, when the drive member 10 rotates in said clockwise direction during the jump phase, returned to its rest position by its return member 11. The flexible finger 16 advantageously has at its back edge, in the clockwise direction, an inclined plane to facilitate its passage behind the tooth 2′ during the winding phase, and at its front end, a straight face configured to come to face the tooth 2′ at the start of the jump phase. During the jump phase, the sudden rotation of the drive member 10, released from the star 8 and brought back by its return member 11, drives a sudden rotation of the jumping disc 1 pushed by the flexible finger 16, by thus realising an hour jump.

In order to limit the rotation of the drive member 10, the latter is arranged to move between two stops, one of which corresponds to the position of the drive member 10 during the rest phase and the other of which corresponds to the position of the drive member 10 at the end of the winding phase. To this end, the drive member 10 has an oblong opening 18 in which a pin 20 integral with the frame circulates. The back edge 18a in the clockwise direction of the opening 18 constitutes a stop for the pin 20 when the drive member 10 arrives in its position during the rest phase and the front edge 18b in the clockwise direction could constitute a stop for the pin 20 when the drive member 10 arrives in its position at the end of the winding phase. The front stop 18b preferably determines play with the position of the drive member 10 at the end of the winding phase. Due to such play, the front stop 18b could only enter into contact with the pin 20 in the event of impacts during the winding phase. Thus, the drive member 10 is limited in movement by at least one of the two stops 18a, 18b.

The timepiece mechanism also comprises a locking device for locking the jumping disc 1 arranged to allow the rotation of the jumping disc 1 in the direction of rotation of the jump, namely the clockwise direction, during the jump phase and to prevent a rotation of the jumping disc 1 at least in said direction of rotation during the rest phase so as to prevent any unintentional jump such as a jump in the event of impacts or a double jump.

According to the present invention, said locking device comprises a locking lever 22 mounted between the jumping disc 1 and the drive member 10 on one and the same level in the example shown. The locking lever is mounted so it is free to rotate about the axis B and is arranged to be able to move freely between a locking position, called the high locking position, in which the locking lever 22, in particular its head 25, is held by the outer circumferential edge 10b of the drive member 10 while being able to form a rotation stop in the direction of rotation of the jump, here the clockwise direction, for the jumping disc 1 during the rest phase, and a release position, called the low release position, in which the locking lever 22, in particular its head 25, is engaged in a notch 24 provided on said outer circumferential edge 10b of the drive member 10 so that said locking lever, in particular its head 25, is disengaged from the jumping disc 1 at least at the start of the jump phase. To this end, said notch 24 is arranged, during the rotation of the drive member 10 in the other direction of rotation, here the counterclockwise direction, to be at least partially positioned facing the head 25 of the locking lever 22 at the start of the jump phase so that the jumping disc 1 is free to rotate, and, following the rotation of the drive member 10 in the direction of rotation of the jump, here the clockwise direction, to no longer be facing the head 25 of the locking lever 22 after the jump phase, or preferably before the end of the jump phase and after the start of the jump phase, so that the locking lever 22 returns to its high locking position. This means that the notch 24 is not facing the head 25 of the locking lever 22 during the rest phase before or after the jump phase, or preferably during the rest phase and after the start of the jump phase up to the end of the jump phase, the notch 24 facing the head 25 at the start of the jump phase.

The locking lever 22 is preferably positioned between the inner circumference 1a of the jumping disc 1 and the outer circumferential edge 10b of the drive member 10, the arm of the locking lever 22 extending approximately concentrically with the jumping disc 1 and with the drive member 10.

At its free end, the locking lever 22 comprises a head 25 having a heel 26 arranged to be able to cooperate with one of the teeth 2 of the jumping disc 1 when it is in its high locking position. The head 25 also comprises, opposite the heel 26, a beak 28 arranged to cooperate with the outer circumferential edge 10b of the drive member 10 when the locking lever 22 is in its high position and to cooperate with the notch 24 of the drive member 10 when the locking lever 22 is in its low release position.

The teeth 2 of the jumping disc 1, the heel 26 and the beak 28 of the locking lever are sized so that, when the locking lever 22 is in its high locking position, a tooth 2 of the jumping disc 1 abuts against the heel 26 in the event of the jumping disk rotating while the beak 28 is held in position by the outer circumferential edge 10b of the drive member 10, and so that, when the locking lever 22 is in its low release position, the engagement of the beak 28 in the notch 24 makes it possible for the locking lever 22 to pivot sufficiently about its axis B so as to move its heel 26 away from the teeth 2 of the jumping disc 1. In this position, said jumping disc 1, in particular each of its teeth 2, can pass over the locking lever 22 and can rotate freely.

The notch 24 is preferably sized and positioned on the outer circumferential edge 10b of the drive member 10 so that the beak 28 of the head 25 of the locking lever 22 falls into the notch 24 during the winding phase, for example at the start of the winding phase, and substantially arrives at the front end of said notch 24 in the direction of rotation of the jump, here the clockwise direction, at the end of the winding phase, so that the heel 26 of the head 25 of the locking lever 22 is at a distance from a tooth 2 during the winding phase, and so that the beak 28 of the head 25 of the locking lever 22 is positioned substantially at the back edge of the notch 24 in said direction of rotation, here the clockwise direction, as soon as the tooth 2 which was locked by the locking lever 22 has been passed. Thus, the locking lever 22 quickly exits the notch 24 and returns to its high locking position during the jump phase so as to be able to lock the next tooth 2 before the drive member 10 reaches its position corresponding to the rest phase.

On the one hand, this makes it possible to guarantee that the locking lever 22 is in its low position at the end of the winding phase, before the start of the jump phase, so as to ensure that the jumping disc 1 rotates freely for the jump phase. On the other hand, this makes it possible to ensure that the locking lever 22 has resumed its high locking position once the relevant tooth 2 has been passed in order to lock the next tooth 2 and to prevent any double jump.

A pin 30 is provided on the frame near the head 25 of the locking lever 22. Said pin 30 can be intended to receive, at its free end, a member of a diameter which makes it possible to cover at least in part the head 25 of the locking lever 22 in order to prevent the locking lever 22 from lifting and to keep it in its working plane. The pin 30 preferably has, at its free end, the aforementioned diameter.

The locking device also advantageously comprises a jumper 32 arranged to allow the jumping disc 1 to rotate freely in the direction of rotation of the jump, here the clockwise direction, during the jump phase and to lock said jumping disc 1 in the other direction of rotation, here the counterclockwise direction, during the rest phase.

To this end, said jumper 32 is mounted, pivoting at C, on the frame. It is associated with a return spring 34. The jumper 32 has at the front, in the direction of rotation of the jump, here the clockwise direction, a front flank 36 which is cut to be substantially perpendicular to the tooth 2″ of the jumping disc 1 located at the front of the jumper 32 in said direction of rotation. In the event of an impact, the jumper 32 makes it possible to prevent a rotation of the jumping disc 1 in the counterclockwise direction, the tooth 2″ being locked by its front flank 36.

The jumper 32 also has a rising flank 38 and a falling flank 40 formed by inclined planes which make it possible to move the jumper 32 by the teeth 2 of the jumping disc 1. In particular, the rising flank 38 makes it possible, by means of the tooth 2″ of the jumping disc 1 which comes into contact with the jumper 32 at the start of the jump phase, to move said jumper 32, against its return spring 34, by moving it away from the jumping disc 1, allowing the rotation of the jumping disc 1 in the clockwise direction. The falling flank 40 makes it possible to complete the rotation of the jumping disc 1 by using the elastic energy of the return spring 34 of the jumper when the latter returns to the rest position. More precisely, when the tooth 2″ of the jumping disc 1, which has moved the jumper 32, comes into contact with the falling flank 40 of the jumper 32, said falling flank 40, rising again to the rest position under the effect of the return force of the spring of the jumper, pushes the jumping disk 1 by sliding its inclined plane with the tooth 2″ of the jumping disk 1. As a result, the falling flank 40 makes it possible to complete the clockwise rotation of the jumping disk 1 so as to reposition it in its rest position, the flank of the tooth 2″ then being in contact with the front flank 36.

The jumper 32 is configured so that, in the position corresponding to the rest phase, its front flank 36 is in contact with a flank of a tooth 2″, and so that the tooth 2 which will follow, in the direction of rotation of the jump, here the clockwise direction, is substantially in contact with the rising flank 38.

The standard operation of the timepiece mechanism according to the invention is described in relation to FIGS. 1 to 7.

During a rest phase shown in FIG. 1, the drive member 10 and the jumping disc 1 are stationary. The pin 20 abuts against the back edge 18a of the opening 18 of the drive member 10. The jumper 32 immobilises the jumping disc 1 under normal conditions of use of the mechanism. The locking lever 22 is held in its high locking position by its beak 28 resting on the outer circumferential edge 10b of the drive member 10, its heel 26 preventing the tooth 2 of the jumping disc 1 from passing over the locking lever 22. A tooth 8a of the drive star 8 driven by the hour wheel approaches the catch 14 of the drive member 10 in order to initiate the winding phase, shown in FIG. 2.

During the winding phase, the drive member 10 is driven, via its catch 14, by the tooth 8a of the drive star 8 in the direction of rotation contrary to the direction of rotation of the jump, namely here in the counterclockwise direction. The effect of this is to wind its elastic return member 11. Its flexible finger 16 retracts upon contact with a tooth 2′ of the jumping disc 1 which remains stationary during the winding phase. Due to the rotation in the counterclockwise direction of the drive member 10, its notch 24 comes to face the beak 28 of the locking lever 22. The latter then has the possibility of tilting in the direction of the notch 24 in its low release position, for example by gravity, so that its heel 26 moves away from the tooth 2 of the jumping disc 1. The jumping disc 1 is no longer locked by the locking lever 22. At the end of the winding phase, the beak 28 of the locking lever 22 is located facing the notch 24, in the clockwise direction, and the pin 20 is preferably near the front edge 18b of the opening 18 of the drive member 10 so as to leave play between the pin and the front edge 18b of the opening 18 when the drive member 10 is completely wound.

At the start of the jump phase, with reference to FIG. 3, the tooth 8a of the star 8 continues its rotation in the counterclockwise direction so that it can no longer drive the catch 14 of the drive member 10. The latter is then released and rotates in the clockwise direction, brought back by its elastic return member 11 so that its flexible finger 16 drives the tooth 2′ of the jumping disc 1 in the clockwise direction. If the locking lever 22 has already fallen into the notch 24 during the winding phase, the jumping disc 1 can rotate freely in the clockwise direction, by moving the jumper 32 by its tooth 2″ resting on the rising flank 38. If the locking lever 22 has not yet fallen into the notch 24 by gravity, the tooth 2 of the jumping disc 1 driven in the clockwise direction by the drive member 10 moves the locking lever 22 by its heel 26, the beak 28 of said locking lever 22 being located facing the notch 24 no longer being held by the outer circumferential edge 10b of the drive member 10. The tooth 2 of the jumping disc 1, having caused the locking lever 22 to fall into the notch 24, can pass over said locking lever 22 which has pivoted sufficiently about its axis B to allow the jumping disc 1 to rotate freely in the clockwise direction.

With reference to FIG. 4, the jump phase continues, the drive member 10 still rotating in the clockwise direction under the effect of its elastic return member 11. Its flexible finger 16 still drives the tooth 2′ of the jumping disc 1 so that the jumping disc 1 continues its rotation in the clockwise direction by continuing to move the jumper 32 against the return spring 34 tending to bring it back into its rest position. Since the drive member 10 has rotated in the clockwise direction, the beak 28 of the locking lever 22 arrives at the back of the notch 24, in the clockwise direction, ready to exit said notch 24.

With reference to FIG. 5, the jump phase continues, the drive member 10 still rotating in the clockwise direction under the effect of its elastic return member 11. Its flexible finger 16 still drives the tooth 2′ of the jumping disc 1 so that the jumping disc 1 continues its rotation in the clockwise direction. The jumper 32 passes the jumping moment, the tooth 2″ of the jumping disc 1 engaging on the falling flank 40. Since the drive member 10 has rotated in the clockwise direction, the locking lever 22 has exited the notch 24 and has returned to its high locking position, so that the next tooth 2″ of the jumping disc 1 will be locked by the heel 26 of the locking lever 22. Thus, a double jump is impossible.

With reference to FIG. 6, the jump phase comes to an end, the back edge 18a of the opening 18 of the drive member 10 preferably comes into abutment against the pin 20 so that the drive member 10 can no longer continue its rotation. The flexible finger 16 can no longer drive the tooth 2′ of the jumping disc 1. The falling flank 40 of the jumper 32, brought back into its rest position by its spring 34, pushes the tooth 2″ of the jumping disc 1 so that the latter completes its rotation in the clockwise direction. The locking lever 22 is in its high locking position, preventing any double jump.

With reference to FIG. 7, the jump phase has been completed and the mechanism has returned to its rest phase. The back edge 18a of the opening 18 of the drive member 10 is preferably in abutment against the pin 20, the jumper 32 has repositioned the jumping disc 1, the tooth 2″ being in contact with its front flank 36. The locking lever 22 is in its high locking position, its beak 28 being held by the outer circumferential edge 10b of the drive member 10. The mechanism is ready for the next jump.

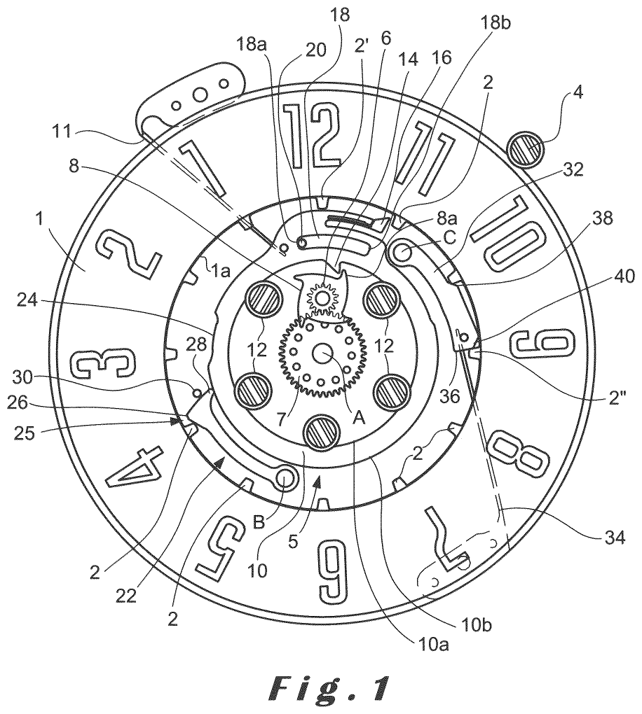

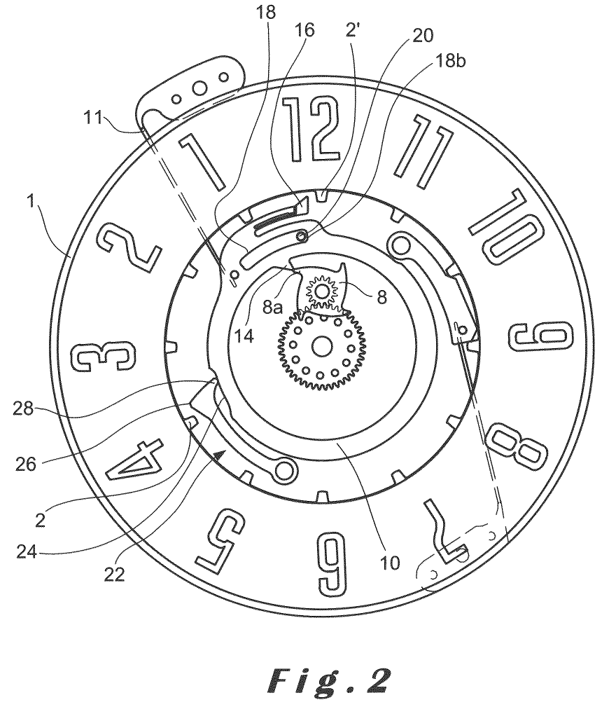

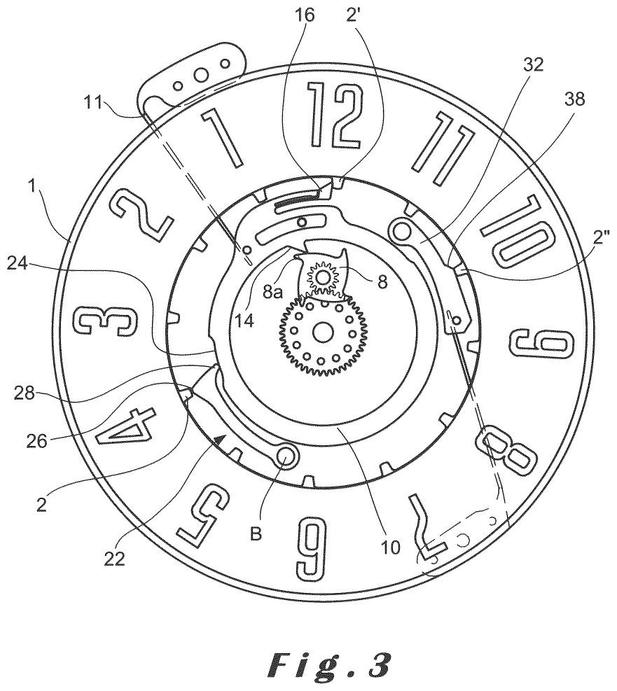

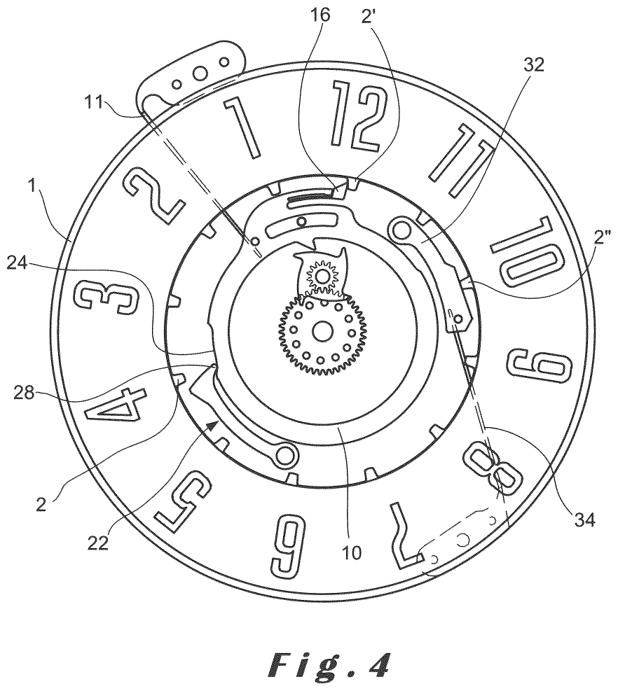

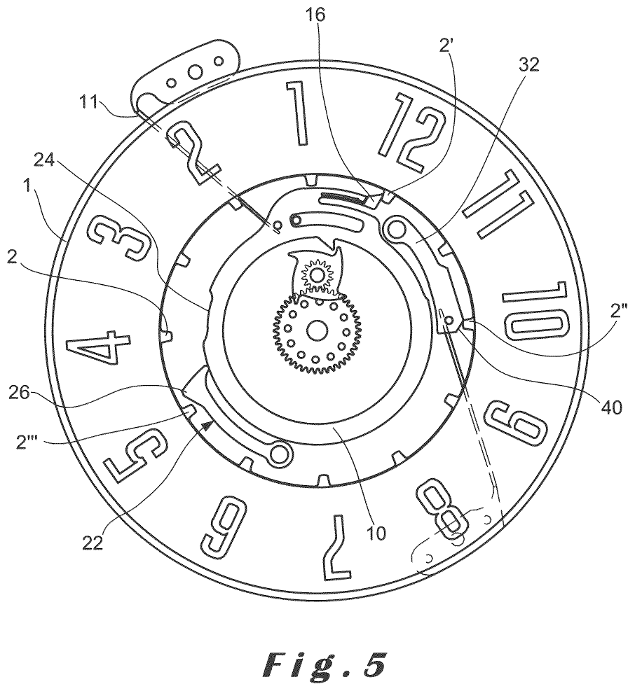

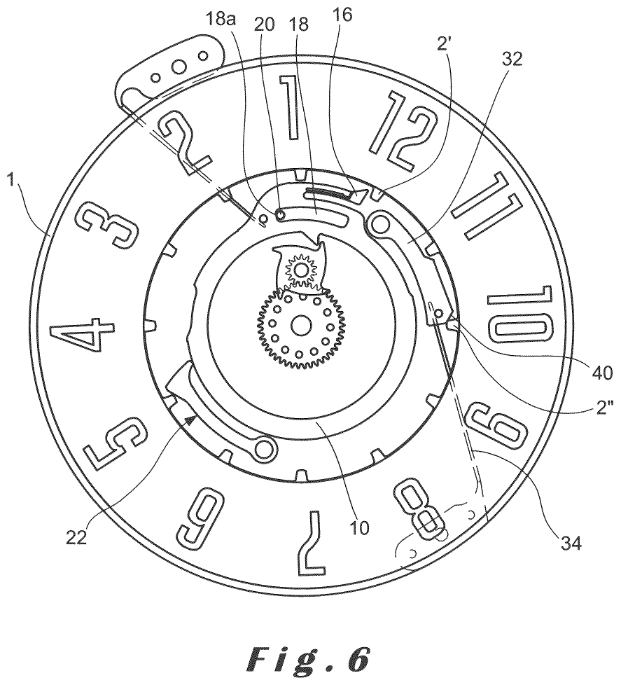

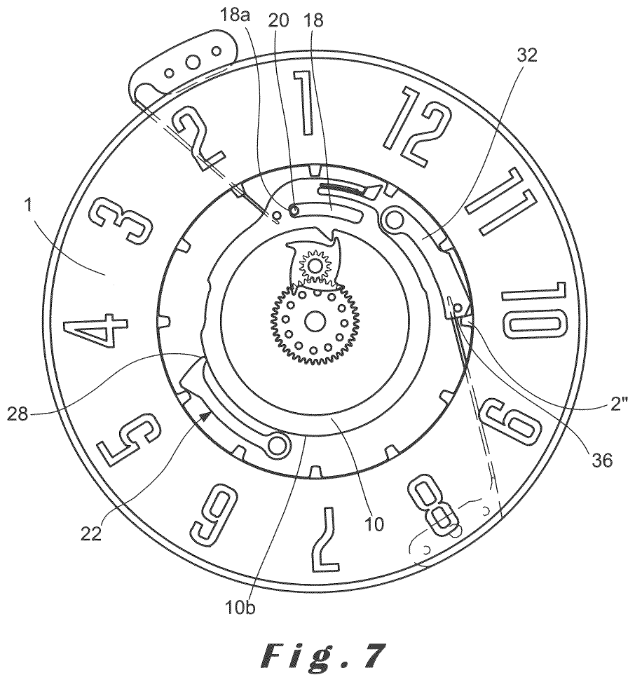

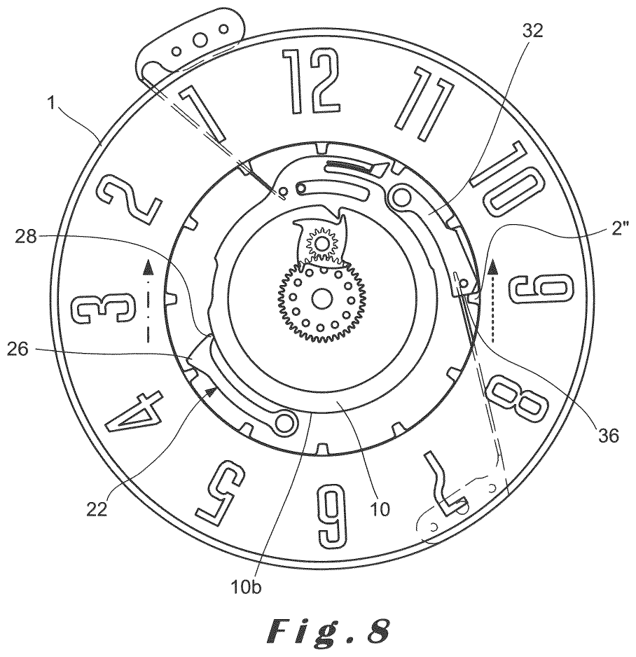

In the event of an impact, for example, with reference to FIG. 8, an unintentional rotation of the jumping disc 1 in the counterclockwise direction is not possible because the jumping disc 1 is locked due to its tooth 2″ being locked by the front flank 36 of the jumper 32. A rotation in the clockwise direction is not possible either, because the jumping disc 1 is locked by the heel 26 of the locking lever 22 which is itself locked in its high locking position by its beak 28 held by the outer circumferential edge 10b of the drive member 10.

Thus, the mechanism according to the invention makes it possible to have a locking device for locking the jumping disc which prevents any unintentional jump in the direction of rotation of the jump, whether it is a double jump or in the event of an impact. With the jumper, the mechanism according to the invention prevents any unintentional jump in the reverse direction of rotation to that of the jump, or even in both directions of rotation if the force of the return spring 34 is too large and thus contributes to the tooth 2 not being able to rise along the rising flank 38.

Furthermore, the mechanism according to the invention uses a locking lever without a return spring in a particularly advantageous manner. In particular, this makes it possible to overcome the problems linked to gravity and energy consumption during the jump phase, the movement of the lever between its locking position and its release position being done without effort, that is to say without having to counteract an opposing force applied to the lever, and to simplify the mechanism. The mechanism of the invention is also simplified and is of more compact construction thanks to the use of one and the same drive member 10 which is configured to be able to perform on its own the three functions of driving the jumping disk 1, locking the lever 22 and releasing the latter.

Furthermore, in the case of a jumping hour disc, the source of energy advantageously originates from the hour wheel. The advantage of this is to have twelve times more torque than if one was engaged with a minute wheel, which is what conventionally happens in jumping hour mechanisms.

The invention is not limited to the example described. For example, the jumping disc and the drive member can be not concentric. Although this mechanism can be advantageously arranged on a single level to benefit from a minimum thickness, it is also possible to provide an arrangement of this mechanism on several levels, where at least two members of the jumping disk 1, the locking lever 22 and the drive member 10 are typically on the same level. For example, it is possible to arrange only the drive member and the jumping disk on the same level, with the locking device being able to be on another level. For example, the locking lever can cooperate with the drive member and the jumping disc by means of pins integral with the drive member, respectively with the jumping disk. This embodiment can be implemented if the mechanism cannot be produced on a single level due to it being too bulky, for example.

1. A timepiece mechanism comprising:
a jumping disc configured to jump by one step in a first direction of rotation;
a driving device configured to drive the jumping disc, the driving device comprising a rotary drive member configured to be, with the jumping disc, stationary during a rest phase, and, during a jump phase, to drive the jumping disc by one step in a jumping manner in said first direction of rotation; and
a locking device configured to lock the jumping disc, the locking device being configured to allow a rotation of the jumping disc in said first direction of rotation during the jump phase and to prevent the rotation of the jumping disc at least in said first direction of rotation during the rest phase, said locking device comprising a locking lever mounted between the jumping disc and the drive member, the locking lever comprising a head, said locking lever being configured to move between a high locking position in which said head is held by an outer circumferential edge of the drive member while being able to form a rotation stop in said first direction of rotation for the jumping disc during the rest phase, and a low release position in which said head is engaged in a notch provided on said outer circumferential edge of the drive member to be disengaged from the jumping disc, said notch being configured to be at least partially positioned facing the head of the locking lever at the a start of the jump phase so that the jumping disc is free to rotate, and to no longer be facing said head one one of after the jump phase, and (ii) before an end of the jump phase, so that the locking lever returns to the high locking position.

2. The timepiece mechanism according to claim 1, wherein the jumping disc and the drive member are concentric.

3. The timepiece mechanism according to claim 1, wherein at least two members of the jumping disc, the locking lever, and the drive member are on a same level.

4. The timepiece mechanism according to claim 1, wherein the locking lever is positioned between the inner circumference of the jumping disc and the outer circumferential edge of the drive member.

5. The timepiece mechanism according to claim 1, wherein the jumping disc comprises, on the inner circumference thereof, at least as many teeth as there are jumps to be made in one revolution, and
the head of the locking lever comprises a heel configured to cooperate with one of the teeth when the locking lever is in the high locking position.

6. The timepiece mechanism according to claim 1, wherein the head of the locking lever comprises a beak configured to cooperate with the outer circumferential edge of the drive member when the locking lever is in the high locking position and to cooperate with the notch of the drive member when the locking lever is in the low release position.

7. The timepiece mechanism according to claim 1, wherein the drive member is associated with an elastic return member, said drive member being configured to be rotated in a second direction of rotation by winding the elastic return member during a winding phase, independently of the jumping disc, and, during the jump phase, to rotate in said first direction of rotation under an effect of the elastic return member by driving the jumping disc by one step in a jumping manner in said first direction of rotation.

8. The timepiece mechanism according to claim 7, wherein the jumping disc includes a tooth, and the notch is sized and positioned on the outer circumferential edge of the drive member so that the head of the locking lever is positioned in the notch substantially at a front end in said first direction of rotation at an end of the winding phase and so that the head of the locking lever is positioned substantially at a back edge of the notch in said first direction of rotation as soon as the tooth which was locked has been passed.

9. The timepiece mechanism according to claim 7, wherein the driving device comprises a drive star comprising teeth to engage with a catch of the drive member in order to rotate the drive member in the second direction of rotation during the winding phase.

10. The timepiece mechanism according to claim 7, wherein the drive member of the jumping disc comprises a flexible finger configured to retract on contact with the jumping disc when the drive member is driven in the second direction of rotation during the winding phase and to drive the jumping disc by one step in the first direction of rotation when the drive member rotates in the first direction of rotation during the jump phase.

11. The timepiece mechanism according to claim 7, wherein the drive member is limited in movement by at least one of two stops, one of the stops corresponding to a first position of the drive member during the rest phase and the other of the stops corresponding to a second position of the drive member at the end of the winding phase or determining play with the second position of the drive member at the end of the winding phase.

12. The timepiece mechanism according to claim 1, wherein the locking device comprises a jumper configured to allow the jumping disc to rotate freely in the first direction of rotation during the jump phase and to lock said jumping disc in the second direction of rotation during the rest phase.

13. The timepiece mechanism according to claim 12, wherein the jumper comprises a falling flank configured to complete the rotation of the jumping disc by using elastic energy of a return spring of the jumper when the jumper returns to the rest position.

14. The timepiece mechanism according to claim 1, wherein the jumping disc is an hour disc, and
the drive member is driven via an hour wheel.

15. A timepiece comprising:
the timepiece mechanism according to claim 1.
